(19) United States
(12) Patent Application Publication
(10) Pub. No.: US 2012/0236274 A1
(43) Pub. Date: Sep. 20, 2012

(54) LIQUID CRYSTAL PANEL MANUFACTURING APPARATUS AND METHOD FOR MANUFACTURING THE LIQUID CRYSTAL PANEL

(75) Inventors: Akihiko TAUCHI, EHIME-KEN (JP); Tadashi TANAKA, EHIME-KEN (JP); Kazuhiro SHIRAISHI, EHIME-KEN (JP); Tai-Hsiang HUANG, ZHUBEI CITY (TW); Te-Jen TSENG, HSINCHU CITY (TW); Norio SUGIURA, HSINCHU CITY (TW)

(73) Assignees: AU OPTRONICS CORPORATION, HSINCHU (TW); HARISON TOSHIBA LIGHTING CORP., IMABARI-SHI (JP)

(21) Appl. No.: 13/414,077

(22) Filed: Mar. 7, 2012

(30) Foreign Application Priority Data
Mar. 10, 2011 (JP) 2011-053133
Mar. 10, 2011 (JP) 2011-053134

(51) Int. Cl. G03B 27/52

(52) U.S. Cl. 355/30

(57) ABSTRACT

According to one embodiment, a liquid crystal panel manufacturing apparatus includes a treatment bath, a light transmissive window, a liquid flowing unit, and a light irradiation unit. The treatment bath is configured to contain a liquid and to treat a panel in the liquid, wherein the panel includes a liquid crystal layer having a photo-polymerizable material and a liquid crystal composition. The light transmissive window is provided in the treatment bath. The liquid flowing unit is configured to cause the liquid to flow along a major surface of the panel. A light irradiation unit is configured to irradiate the panel with a light to polymerize the photo-polymerizable material via the light transmissive window.

### CROSS-REFERENCE TO RELATED APPLICATIONS

This application is based upon and claims the benefit of priority from the prior Japanese Patent Application No. 2011-053133, filed on Mar. 10, 2011 and Japanese Patent Application No. 2011-053134, filed on Mar. 10, 2011; the entire contents of which are incorporated herein by reference.

### FIELD

Embodiments described herein relate generally to a liquid crystal panel manufacturing apparatus and a method for manufacturing the liquid crystal panel.

### BACKGROUND

There is a liquid crystal panel using a liquid crystal layer in which a photo polymerizable material and a liquid crystal are mixed. For example, in a polymer-dispersed liquid crystal, liquid crystal grains are dispersed in a polymer matrix. Furthermore, there is also a configuration using such a liquid crystal layer for the purpose of adding orientation. Moreover, a polymer-stabilized blue phase can also be obtained by irradiating a layer in which, for example, a liquid crystal made by mixing a nematic liquid crystal, and a chiral material and a photo polymerizable material are mixed, with UV light.

In manufacture of such a liquid crystal panel, there is an approach in which an UV lamp performs irradiation with UV light for polymerizing a photo-polymerizable material. At the time of UV irradiation, the temperature of the liquid crystal panel is desired to be uniform in the panel face. In particular, in a configuration using a polymer-stabilized blue phase (PSBP), effects of temperature variation in the panel face at the time of light irradiation, applied to variation in display characteristics are great.

In manufacture of such a liquid crystal panel, in order to control the temperature when irradiation with light is performed for polymerizing a photo-polymerizable material, there is a configuration in which the panel to be treated is irradiated with light in a state of being put in a liquid. For example, if the liquid is adhered to the panel to be treated when the panel to be treated is taken out from the liquid after being irradiated with light, in some cases, adverse effects may be exerted at processes after that, thereby generating a practical problem.

### BRIEF DESCRIPTION OF THE DRAWINGS

FIG. 1 is a schematic view illustrating the configuration of a liquid crystal panel manufacturing apparatus according to a first embodiment;

FIG. 2 is a schematic plan view illustrating the configuration of the liquid crystal panel manufacturing apparatus according to the first embodiment;

FIG. 3 is a graph view illustrating characteristics of liquid crystal panel manufacturing apparatuses;

FIGS. 4A and 4B are schematic views illustrating the configurations of liquid crystal panel manufacture apparatuses according to reference examples;

FIG. 5 is a schematic perspective view illustrating the configuration of a part of the liquid crystal panel manufacturing apparatus according to the first embodiment;

FIG. 6 is a schematic view illustrating the configuration of another liquid crystal panel manufacturing apparatus according to the first embodiment;

FIGS. 7A and 7B are graph views illustrating the characteristics of the liquid crystal panel manufacturing apparatus according to the first embodiment;

FIG. 8 is a schematic cross-sectional view illustrating the configuration of a part of the liquid crystal panel manufacturing apparatus according to the first embodiment;

FIG. 9 is a schematic view illustrating the configuration of another liquid crystal panel manufacturing apparatus according to the first embodiment;

FIG. 10 is a schematic view illustrating the configuration of a liquid crystal panel manufacturing apparatus according to a second embodiment;

FIG. 11 is a flow chart view illustrating a manufacturing method of a liquid crystal panel according to a third embodiment;

FIG. 12 is a schematic plan view illustrating the configuration of a liquid crystal manufacturing apparatus according to a fourth embodiment;

FIG. 13 is a schematic cross-sectional view illustrating the configuration of the liquid crystal manufacturing apparatus according to the fourth embodiment;

FIG. 14 is a schematic view illustrating the configuration of the liquid crystal panel manufacturing apparatus according to the fourth embodiment;

FIGS. 15A to 15C are schematic views illustrating the configurations of liquid crystal panel manufacturing apparatuses according to the fourth embodiment;

FIG. 16 is a schematic plan view illustrating the configuration of another liquid crystal panel manufacturing apparatus according to the fourth embodiment; and

FIG. 17 is a schematic cross-sectional view illustrating the configuration of another liquid crystal panel manufacturing apparatus according to the fourth embodiment.

### DETAILED DESCRIPTION

According to one embodiment, a liquid crystal panel manufacturing apparatus includes a treatment bath, a light transmissive window, a liquid flowing unit, and a light irradiation unit. The treatment bath is configured to contain a liquid and to treat a panel in the liquid, wherein the panel includes a liquid crystal layer having a photo-polymerizable material and a liquid crystal composition. The light transmissive window is provided in the treatment bath. The liquid flowing unit is configured to cause the liquid to flow along a major surface of the panel. A light irradiation unit is configured to irradiate the panel with a light to polymerize the photo-polymerizable material via the light transmissive window.

According to another embodiment, a method is disclosed for manufacturing a liquid crystal panel. The method can include housing a panel to be treated in a liquid introduced inside a treatment bath provided with a light transmissive window. The panel to be treated includes a liquid crystal layer containing a photo-polymerizable material and a liquid crystal composition. The method can include irradiating the panel to be treated with a light for polymerizing the photo-polymerizable material via the window while causing the liquid in contact with the panel to be treated and the window to flow along a major surface of the panel to be treated.

According to another embodiment, a liquid crystal panel manufacturing apparatus includes a treatment bath, a light irradiation unit, and a liquid remover. The treatment bath retains a liquid in an inside of the treatment bath and houses a panel to be treated in the liquid. The panel to be treated includes a liquid crystal layer containing a photo-polymerizable material and a liquid crystal composition. The light irradiation unit irradiates the panel to be treated housed in the inside of the treatment bath with a light polymerizing the photo-polymerizable material. The liquid remover removes the liquid adhered to at least a portion of the panel to be treated. The portion is taken out from the liquid.

According to another embodiment, a method is disclosed for manufacturing a liquid crystal panel. The method can include housing a panel to be treated in a liquid introduced inside a treatment bath. The panel to be treated includes a liquid crystal layer containing a photo-polymerizable material and a liquid crystal composition. The method can include irradiating the panel to be treated with a light polymerizing the photo-polymerizable material. In addition, the method can include removing the liquid adhered to at least a portion of the panel to be treated, the portion being taken out from the liquid.

Embodiments will be described hereinafter with reference to the accompanying drawings.

The drawings are schematic or conceptual; and the relationships between the thicknesses and widths of portions, the proportions of sizes among portions, etc., are not necessarily the same as the actual values thereof. Furthermore, the dimensions and the proportions may be illustrated differently among the drawings, even for identical portions. In the specification and the drawings of the application, components similar to those described in regard to a drawing thereinabove are marked with like reference numerals, and a detailed description is omitted as appropriate.

### First Embodiment

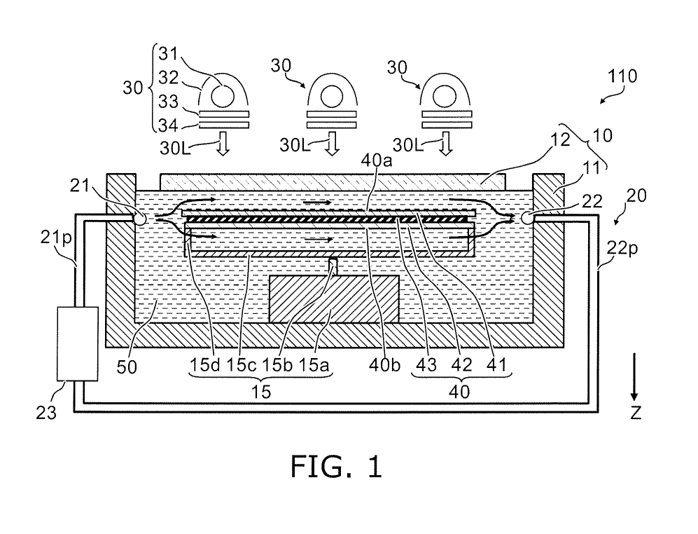

FIG. 1 is a schematic view illustrating the configuration of a liquid crystal panel manufacturing apparatus according to a first embodiment.

In FIG. 1, cross-sections of some constituent elements are shown, and some of others are shown schematically.

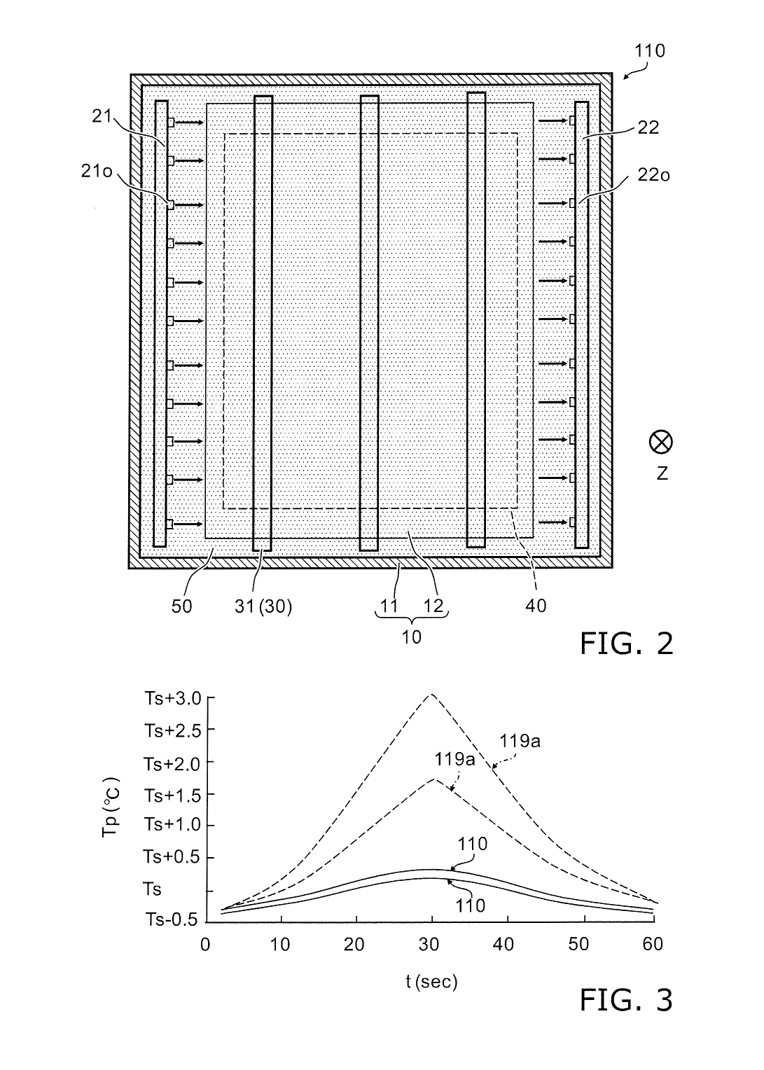

FIG. 2 is a schematic plan view illustrating the configuration of the liquid crystal panel manufacturing apparatus according to the first embodiment.

In FIG. 2, some of the elements illustrated in FIG. 1 are omitted.

As shown in FIGS. 1 and 2, the liquid crystal panel manufacturing apparatus 110 according to the embodiment is provided with a treatment bath 10, a window 12, a liquid flowing unit 20, and a light irradiation unit 30.

The treatment bath 10 retains a liquid 50 therein. A panel 40 to be treated (hereinafter, referred to as the panel 40) is housed in the liquid 50 of the treatment bath 10. The window 12 is provided in the treatment bath 10. The window 12 contacts the liquid 50. In addition, the window 12 is light transmissive.

As the treatment bath 10, for example, stainless steel etc. can be used. As the window 12, UV transmissive glass can be used. For example, at least one of quartz glass or boron silicate glass can be used as the window 12. Furthermore, for example, PYREX (registered trademark) can also be used as the window 12.

In this example, the treatment bath 10 includes a container 11 and the window 12. The container 11 retains the liquid 50 therein. The container houses a panel 40 in the liquid 50.

For example, the treatment bath 10 includes a panel holder 15 for holding the panel 40. The panel holder 15 includes, for example, a base 15a, an axis 15b, an arm 15c, and a placement part 15d. The base 15a is fixed to the bottom of the container 11. The axis 15b is fixed to the base 15a. The arm 15c combines the placement part 15d and the axis 15b. For example, the length of the arm 15c is variable. The panel 40 is placed on the placement part 15d. There are spaces on the upper face and the bottom face of the panel 40. The spaces are filled with the liquid 50.

The window 12 faces the panel 40 via the liquid 50. That is, the liquid 50 between the window 12 and the panel 40 contacts the window part 12 and the panel 40.

The panel 40 includes a liquid crystal layer 43. The liquid crystal layer 43 contains a photo-polmerizable material and a liquid crystal composition. The liquid crystal composition contains, for example, a nematic liquid crystal and a chiral material. The photo-polmerizable material contains, for example, a UV curable monomer. The photo-polmerizable material contains, for example, an acryl-based monomer. The embodiment is not limited to the above, and any photo-polmerizable material can be used, and any liquid crystal composition can be used.

The panel 40 further includes, for example, a first substrate 41 and a second substrate 42. The second substrate 42 faces the first substrate 41. The liquid crystal layer 43 is disposed between the first substrate 41 and the second substrate 42. A seal material (not shown) is provided at the periphery of the liquid crystal layer 43 between the first substrate 41 and the second substrate 42. Therefore, the liquid crystal layer 43 is sealed by the first substrate 41, the second substrate 42 and the seal material.

The panel 40 has a first major surface 40a (major surface) and a second major surface 40b. The first major surface 40a is a surface at the side facing the window 12. The second major surface 40b is a surface on the side opposite to the first major surface 40a.

The liquid flowing unit 20 causes the liquid 50 between the panel 40 and the window 12 to flow along a major surface (for example, the first major surface 40a) of the panel 40. That is, the liquid flowing unit 20 causes the liquid 50 between the panel 40 and the window 12 to flow. Furthermore, the liquid flowing unit 20 can further cause the liquid 50 being in contact with the second major surface 40b (a plane on the side opposite to the window 12) of the panel 40, to flow.

Because of this, the liquid 50 flows along the first major surface 40a of the panel 40. Furthermore, the liquid 50 also flows along the second major surface 40b of the panel 40. In this way, uniformity in the temperature of the panel 40 becomes higher by causing the liquid 50 along the major surface of the panel 40 to flow.

The light irradiation unit 30 irradiates the panel 40 housed inside the treatment bath 30, with light 30L for polymerizing a photo-polymerizable material.

As mentioned above, in the embodiment, by causing the liquid 50 to flow along the major surface of the panel 40, uniformity in the temperature of the panel 40 becomes high. Because of this, the panel 40 is irradiated with light in a state where the uniformity in the temperature of the panel 40 is high. Then, the photo-polymerizable material is polymerized and a liquid crystal panel is manufactured.

According to a liquid crystal panel manufacturing apparatus 110, light irradiation can be performed under a uniform condition (specifically uniform temperature distribution).

As shown in FIG. 1, in the liquid crystal panel manufacturing apparatus 110, an axis directing from the light irradiation unit 30 toward the window 12 (an axis directing from the light irradiation unit 30 toward a portion of the window 12 nearest to the light irradiation unit 30) is substantially parallel to a direction of gravity (z-axis direction). For example, a major surface of the window 12 is substantially perpendicular to the z-axis direction. The major surface of the panel 40 is substantially perpendicular to the z-axis direction.

The liquid flowing unit 20 can include, for example, a temperature controller 23 for controlling the temperature of the liquid 50. The liquid flowing unit 20 can further include, for example, a supplier 21, a supply pipe 21p, a drain 22, and a drain pipe 22p.

The supplier 21 supplies the liquid 50 into the treatment bath 10. The drain 22 discharges the liquid 50 from the inside of the treatment bath 10. The supply pipe 21p connects the temperature controller 23 and the supplier 21. The drain pipe 22p connects the drain 22 and the temperature controller 23.

The liquid 50 supplied from the supplier to the inside of the treatment bath 10 flows along the first major surface 40a of the panel 40, and is discharged from the drain 22. Furthermore, the liquid 50 flows along the second major surface 40b of the panel 40, and is discharged from the drain 22. The liquid 50 discharged by the drain 22 reaches the temperature controller 23.

The temperature controller 23 controls the temperature of the liquid 50. The temperature controller 23 heats the liquid 50. Alternatively, the temperature controller 23 cools the liquid 50. In this way, the temperature of the liquid 50 is controlled to be a desired temperature. The liquid 50 came out of the temperature controller 23 reaches the supplier 21 via the supply pipe 21p. Then, the liquid 50 is again supplied to the treatment bath 10 from the supplier 21. Thus, the liquid 50 is circulated via the temperature controller 23 provided outside the treatment bath 10. The liquid flowing unit 20 circulates the liquid 50 along a path between the treatment bath 30 and the temperature controller 23.

However, the above is mere an example, and, in the embodiment, the configuration of the liquid flowing unit 20 is arbitrary. For example, the liquid 50 may flow only inside the treatment bath 10.

The liquid 50 is, for example, water. As the liquid 50, for example, pure water or ultrapure water being excellent in UV transparency can be used. The embodiment is not limited to this, and any technically possible material can be used as the liquid 50. The temperature of the liquid 50 is controlled. For example, the temperature of the liquid 50 is not less than 25° C. and not more than 90° C.

As shown in FIG. 2, the supplier 21 can have a plurality of openings 21o. Furthermore, the drain 22 can have a plurality of openings 22o. By being supplied from the plurality of openings 21o, and being discharged from the plurality of openings 22o, flow of the liquid 50 is made uniform further.

In a case where a plurality of openings 22o are present, flow at the center side tends to be faster and flow at the periphery side tends to be lower. As a countermeasure to this, for example, a configuration in which the size of holes at the periphery side made larger than the size of holes at the center side may be used. Furthermore, a configuration in which the number of holes at the periphery side made larger than the number of holes at the center side may be used. By using such configurations, the above mentioned non-uniform flow can be suppressed.

In the treatment bath 10, the panel 40 is disposed between the supplier 21 and the drain 22. By bringing the panel 40 into contact with the liquid 50 having uniform flow, in-plane uniformity in the temperature of the panel 40 becomes higher.

In this way, the panel 40 is irradiated with light in a state where uniformity in the temperature of the panel 40 is high.

The flow rate of the liquid 50 between the panel 40 and the window 12 is, for example, not less than 1 m/s (meter/second) and not more than 10 m/s. If the flow rate is high, uniformity in the temperature of the panel 40 becomes higher.

As illustrated in FIG. 1, the light irradiation unit 30 can include, for example, a light source 31, a reflector 32, a long-wavelength-light cutting filter 33, and a short-wavelength-light cutting filter 34. The light source 31 generates light for polymerizing a photo-polmerizable material. The light source 31 is disposed between the reflector 32 and the window 12. The reflector 32 reflects a portion of light emitted from the light source 31 toward the window 12.

The long-wavelength-light cutting filter 33 is provided between the light source 31 and a position of the treatment bath 10 for housing the panel 40. The long-wavelength-light cutting filter 33 is, for example, an infrared-light cutting filter for attenuating infrared light. The long-wavelength-light cutting filter 33 attenuates light having wavelength of, for example, not less than 400 nanometers (nm). Thereby, the temperature rise of the panel 40 irradiated with light 30L is suppressed.

The short-wavelength-light cutting filter 34 is provided between the light source 31 and the position of the treatment bath 10 for housing the panel 40. The short-wavelength-light cutting filter 34 attenuates light having a wavelength of, for example, not more than 340 nm. Thereby, for example, degradation, by light 30L, of a material (for example, an organic material) contained in the panel 40 is suppressed.

The window 12 of the treatment bath 10 has transparency to light 30L.

Thereby, the panel 40 is effectively irradiated with light having a wavelength required for polymerizing a photo-polymerizable material.

However, even in a case where the above filters are provided, it is difficult to make the temperature of the panel 40 to be perfectly constant by irradiation with light 30L, the temperature of the panel 40 is raised.

FIG. 3 is a graph view illustrating characteristics of liquid crystal panel manufacturing apparatuses.

FIG. 3 illustrates temperature change of the panel 40 when it is irradiated with light 30L in manufacturing a liquid crystal panel. In the figure, characteristics of the apparatus 110 for manufacturing a liquid crystal panel according to the embodiment, and characteristics of a liquid crystal panel manufacturing apparatus 119a for manufacturing a liquid crystal panel according to a first reference example, are shown. In the apparatus 119a according to the first reference example, a liquid 50 between a panel 40 and a window 12 does not flow. That is, a liquid flowing unit 20 is not provided. Except for this, the configuration of the liquid crystal panel manufacturing apparatus 119a is the same as the configuration of the liquid crystal panel manufacturing apparatus 110.

Time for the panel 40 with light 30L is 30 seconds (s). The horizontal axis in FIG. 3 represents time t. Time period between t=0 to t=30 s corresponds to a time period in which the panel 40 is irradiated with light 30L. Time period in which t is larger than 30 s, corresponds to a time period in which irradiation of the panel 40 with light 30L is finished.

The vertical axis in FIG. 3 represents temperature Tp of the panel 40. In FIG. 3, two curves are shown for the liquid crystal panel manufacturing apparatus 110. One of the two curves corresponds to temperature Tp of a higher temperature region in the face of the panel 40, and the other corresponds to temperature Tp of a lower temperature region in the face of the panel 40. Similarly, two curves are shown for the liquid crystal panel manufacturing apparatus 119a. One of the two curves corresponds to temperature Tp of a higher temperature region in the face of the panel 40, and the other corresponds to temperature Tp of a lower temperature region in the face of the panel 40. In FIG. 3, temperatures Tp are represented using a standard temperature Ts.

As shown in FIG. 3, for the liquid crystal panel manufacturing apparatus 119a according to the first reference example, temperature Tp rises largely as time t passes. For example, temperature Tp before the panel 40 is irradiated with light 30L rises by about 3.5° C. than temperature Tp when irradiation of the panel 40 with light 30L is completed (time t is 30 s). Furthermore, the difference between temperature Tp of the higher temperature region and temperature Tp of the lower temperature region is about 1.5° C., which is large.

In the first reference example, since the liquid 50 between the panel 40 and the window 12 does not flow, it is considered that by being irradiated with light 30L, the panel 40 is heated, and thus the temperature of the panel 40 rises largely. Furthermore, since the heat dissipation property is non-uniform in the panel 40, it is considered that temperature variation in the face of the panel 40 is also large.

In contrast to this, in the liquid crystal panel manufacturing apparatus 110 according to the embodiment, temperature Tp changes a little. For example, temperature Tp before the panel 40 is irradiated with light 30L rises by about 1.0° C. than temperature Tp when irradiation of the panel 40 with light 30L is completed (time t is 30 s). Furthermore, difference between temperature Tp of the higher temperature region and temperature Tp of the lower temperature region is about 0.3° C., which is very small.

In the embodiment, since the liquid 50 between the panel 40 and the window 12 flows, it is considered that the temperature of the panel 40 is taken by the liquid 50, and thus temperature rise is small. Furthermore, it is considered that since heat is dissipated uniformly in the panel 40, temperature variation in the face of the panel 40 is small. According to the liquid crystal panel manufacturing apparatus 110, the difference between the maximum temperature and the minimum temperature in the panel 40 when the panel 40 is irradiated with light 30L, can be, for example, not more than 5° C., preferably, not more than 1° C. Thus, according to the embodiment, the panel 40 can be irradiated with light under a uniform condition.

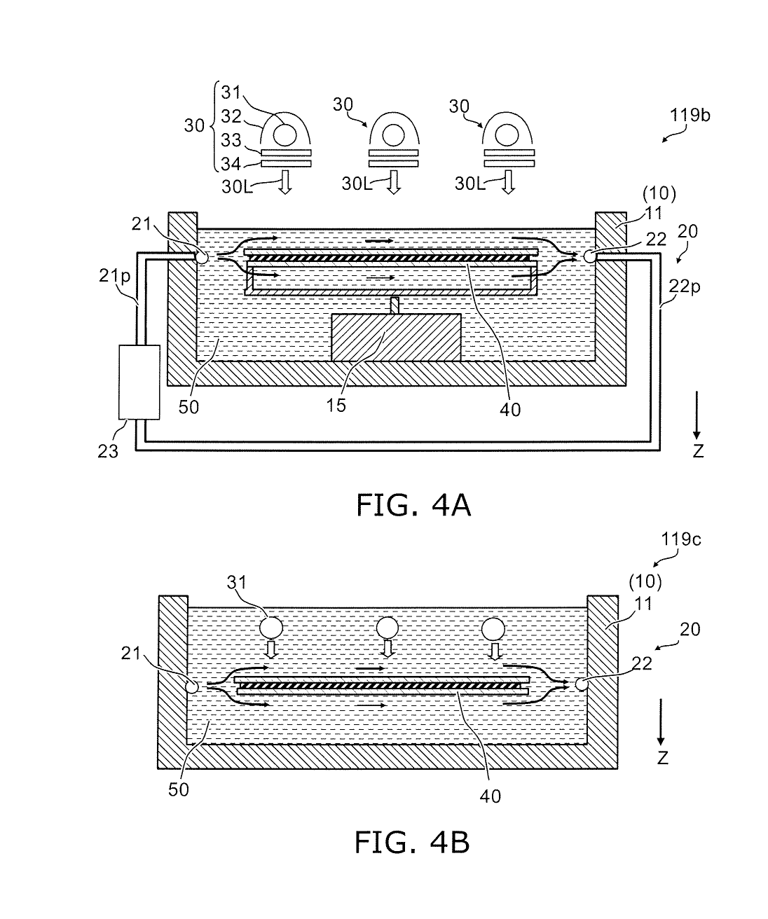

FIGS. 4A and 4B are schematic views illustrating configurations of liquid crystal panel manufacture apparatuses according to reference examples.

That is, FIG. 4A corresponds to a liquid crystal panel manufacturing apparatus 119b according to a second reference example, and FIG. 4B corresponds to a liquid crystal panel manufacturing apparatus 119c according to a third reference example.

As shown in FIG. 4A, the liquid crystal panel manufacturing apparatus 119b is not provided with the window 12. For this reason, for the liquid crystal panel manufacturing apparatus 119b, when the liquid 50 on the panel 40 flows, waves tend to be generated on the surface of the liquid 50. Bubbles also tend to be generated on the surface of the liquid 50. If such waves and bubbles are generated, in-plane non-uniformity in the temperature of the panel 40 tends to be generated. Furthermore, by the waves and bubbles, change in the optical path of light 30L and non-uniformity in intensity of light 30L when the panel 40 is irradiated with light 30L, tend to be generated. In this way, in the second reference example, when the panel 40 is irradiated with light 30L, the temperature of the panel 40 and the intensity of light 30L become non-uniform.

In contrast to this, since the liquid crystal panel manufacturing apparatus 110 is provided with the window 12, generation of waves and bubbles can be suppressed. Thereby, the temperature of the panel 40 and the intensity of light 30L when the panel 40 is irradiated with light 30L, can be made uniform.

As shown in FIG. 4B, in the liquid crystal panel manufacturing apparatus 119c, the light source 31 is buried in the liquid 50. For this reason, heat of the light source 31 tends to be transferred to the panel 40 via the liquid 50. For this reason, in the third reference example, the temperature of the panel 40 tends to be raised. In addition to this, the in-plane temperature of the panel 40 also tends to be non-uniform.

In contrast to this, in the liquid crystal panel manufacturing apparatus 110, the light source 31 (light irradiation unit 30) is provided outside the window 12. For this reason, for example, air can be intervened between the window 12 and the light source 31 (light irradiation unit 30). Thereby, transfer of heat can be suppressed. Because of this, the temperature of the panel 40 does not rise easily, and the in-plane temperature is uniform.

A configuration in which the window 12 and the liquid do not contact each other, and a gap is present between the window 12 and the liquid 50 can also be considered. In the configuration, water-drops preventing uniformity of light adhere to the window 12. When the temperature of the liquid 50 is high, the water-drops turn into steam to haze the window 12, and thus the transparency is further prevented.

In contrast to this, in the liquid crystal panel manufacturing apparatus 110, since the window 12 is in contact with the liquid 50, generation of waves and bubbles is suppressed and generation of haze is also suppressed. Thereby, the intensity of light 30L is further maintained to be uniform.

The temperature of the liquid 50 is, for example, higher than a room temperature. The temperature of the liquid 50 is, for example, not less than 40° C. That is, the temperature of the panel 40 when being irradiated with light 30L is, for example, not less than 40° C. In this way, when the temperature of the liquid 50 is 40° C., the liquid 50 evaporates easily. In the embodiment, generation of haze is suppressed even under such conditions.

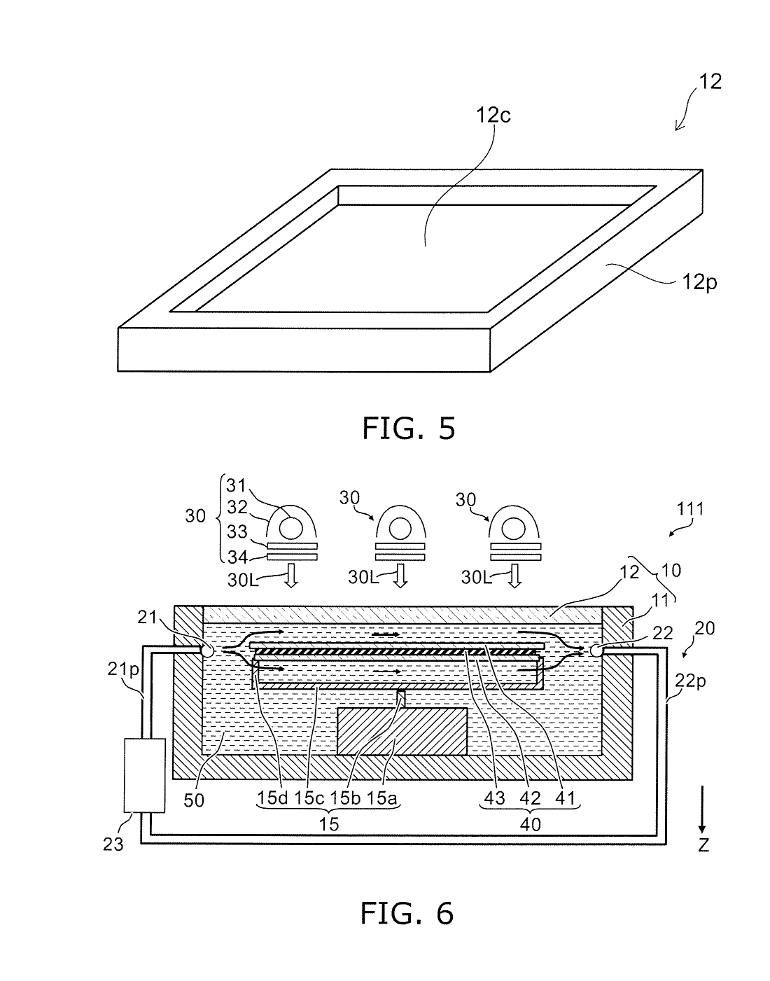

FIG. 5 is a schematic perspective view illustrating the configuration of a part of the liquid crystal panel manufacturing apparatus according to the first embodiment.

In the figure, an example of the configuration of the window 12 is shown. As shown in FIG. 5, the window 12 can have an inside part 12c and a frame 12p. The thickness of the frame 12p is larger than the thickness of the inside part 12c. A surface (bottom face) of the window 12 being in contact with the liquid 50 is a flat plane over the entire window 12. That is, the bottom face of the inside part 12c and the bottom face of the frame 12p are located on the same plane. The frame 12p is projected on a side higher than the side of the inside part 12c. By using such a configuration, it is possible to suppress that the liquid 50 (or liquid-drops) located on the top face of the window 12, especially, the inside part 12c. When the liquid 50 is located on the top face of the window 12, irradiation of light may be uniform, but by using the above configuration, the panel 40 can be uniformly irradiated with light.

FIG. 6 is a schematic view illustrating the configuration of another liquid crystal panel manufacturing apparatus according to the first embodiment.

As shown in FIG. 6, in the liquid crystal panel manufacturing apparatus 111 according to the embodiment, the liquid 50 is covered with the window 12. That is, the liquid 50 is substantially sealed by the treatment bath 10. Thereby, for example, the outflow of a gas of the liquid 50 to the outside of the treatment bath 10 can be suppressed by evaporation of the liquid 50. Therefore, accuracy of temperature control of the liquid 50 is enhanced. Furthermore, adverse effects on the surrounding of a place where the liquid crystal manufacturing apparatus 111 is installed can be suppressed.

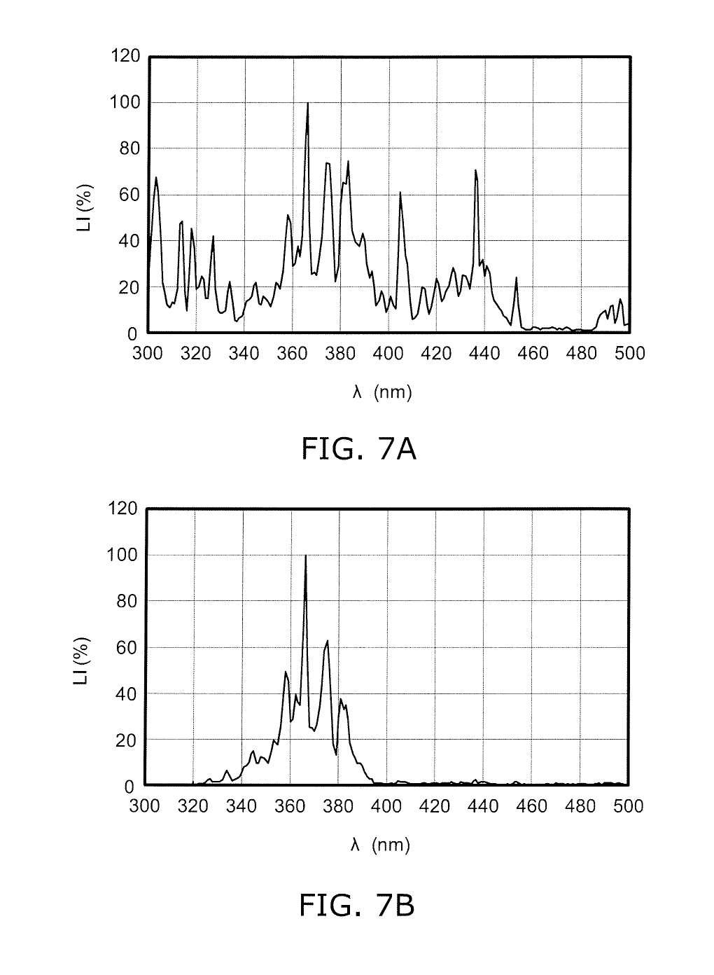

FIGS. 7A and 7B are graph views illustrating the characteristics of the liquid crystal panel manufacturing apparatuses according to the first embodiment.

That is, FIG. 7A illustrates the characteristics of light generated by the light source 31 (before passing through the long-wavelength-light cutting filter 33 and the short-wavelength-light cutting filter 34). The FIG. 7B illustrates the characteristics of light (light 30L) having been emitted by the light source 31 and having passed through the long-wavelength-light cutting filter 33 and the short-wavelength-light cutting filter 34. The horizontal axes in FIGS. 7A and 7B represent wavelength λ. The vertical axes in these figures represent relative intensity LI of light. In this example, as the light source 31, an iron-metal halide lamp is used. The iron-metal halide lamp is a lamp, in which mercury, iron and/or iron halide, and gas are enclosed in a cylindrical glass tube made of, for example, quartz glass etc. and a pair of electrodes are disposed at both ends in the glass tube.

As shown in FIG. 7A, for the light generated by the light source 31, the relative intensity of the light is large in both of a short wavelength range of about 300 nm to about 340 nm and a long wavelength range of about 400 nm to about 460 nm.

In contrast to this, as shown in FIG. 7B, for the light (light 30L) passed through the long-wavelength-light cutting filter 33 and the short-wavelength-light cutting filter 34, the relative intensity LI is very small in both of a wavelength range of not more than 340 nm and a wavelength range of not less than 400 nm.

In this way, by using the long-wavelength-light cutting filter 33 and the short-wavelength-light cutting filter 34, the panel 40 is efficiently irradiated with light having a wavelength required for polymerizing the photo-polymerizable material of the panel 40.

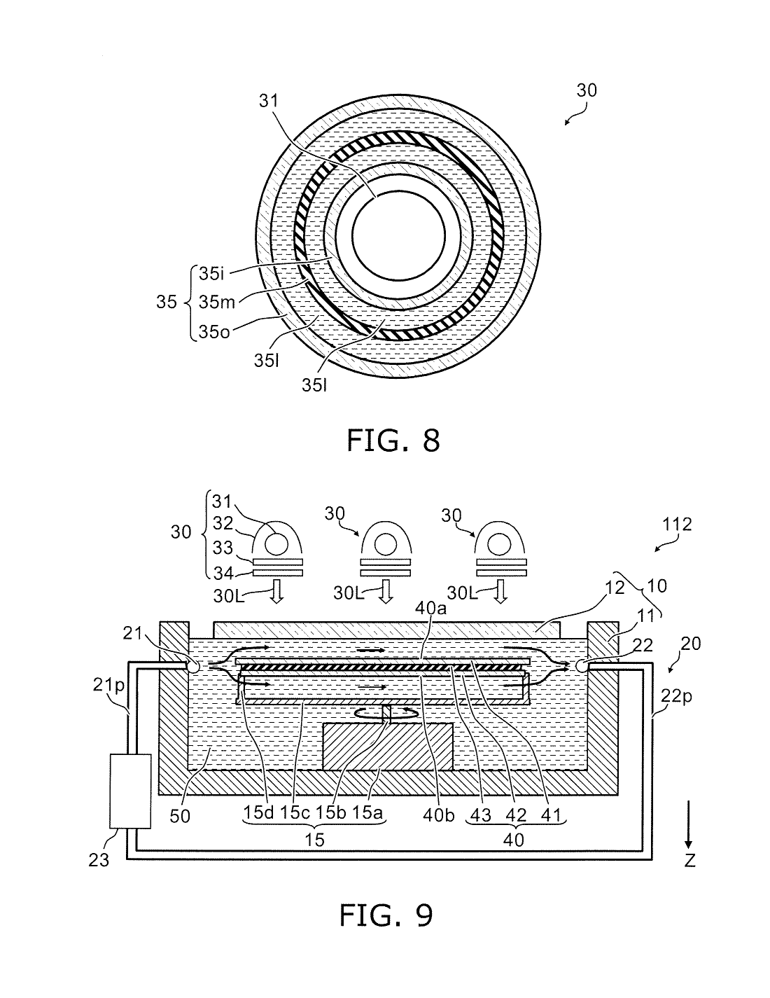

FIG. 8 is a schematic cross-sectional view illustrating the configuration of a part of the liquid crystal panel manufacturing apparatus according to the first embodiment.

The figure shows another example of the configuration of the light irradiation unit 30.

As shown in FIG. 8, in the example, the light irradiation unit 30 includes a light source 31 and a double-pipe liquid cooler 35. The light source 31 emits light (for example, UV light) for polymerizing a photo-polmerizable material.

The double-pipe liquid cooler 35 includes an inner pipe 35i, an outer pipe 35o, and a middle wall 35m. The inner pipe 35i includes the light source 31 therein while being separated from the light source 31. The outer pipe 35o is provided outside the inner pipe 35i. The middle wall 35m is provided between the inner pipe 35i and the outer pipe 35o. A cooling liquid 35l can be introduced between the inner pipe 35i and the middle wall 35m. The cooling liquid 35l can also be introduced between the outer pipe 35o and the middle wall 35m. The cooling liquid 35l can mutually circulate in a space between the inner pipe 35i and the middle wall 35m and a space between the outer pipe 35o and the middle wall 35m. Because of this, in the example, the cooling efficiency is high.

Furthermore, the middle wall 35m can have at least one of a function of the long-wavelength-light cutting filter 33 and a function of the short-wavelength-light cutting filter 34. For example, the middle wall 35m is an infrared cutting filter. The window 12 may also have a function of a filter. In particular, it is desirable to form the infrared cutting filter and a heat absorbing filter. By this, the middle wall 35m can be omitted. Furthermore, the window 12, the temperature of which is raised by infrared light, can be cooled by the liquid 50 in the treatment bath 10.

Moreover, at least one of the inner pipe 35i and the outer pipe 35o can have a function of one of the long-wavelength-light cutting filter 33 and the short-wavelength-light cutting filter 34. Because of this, it is possible to omit providing the long-wavelength-light cutting filter 33 or the short-wavelength-light cutting filter 34 separately.

The light sources 31 may be a thallium-metal halide lamp containing thallium and/or thallium halide and an iron-thallium-metal halide lamp containing iron and thallium.

Furthermore, the light source 31 may be an ultraviolet fluorescent lamp (UV-FL). The ultraviolet fluorescent lamp may have a cylindrical glass tube made from quartz glass etc., in which mercury and a gas are enclosed, an electrode is disposed, and a fluorescent substance layer is formed on the inner wall of the glass tube. As the gas, a single gas or a mixture gas of a rare gas such as neon, argon, and xenon can be used. As the electrode, for example, a hot-cathode electrode can be used. As the fluorescent substance layer, for example, a fluorescent substance layer containing a fluorescent substance capable of converting 254 nm light generated by mercury into 300 to 400 nm light, can be used. As the fluorescent substance capable of converting 254 nm light into 300 to 400 nm light, there is LaPO₄:Ce (trivalent cerium activated lanthanum phosphate) etc. A fluorescent substance layer made by mixing a plurality kinds of fluorescent substances may be used depending on a required wavelength.

In using such an ultraviolet fluorescent lamp as the light source 31, a plurality of ultraviolet fluorescent lamps are disposed in parallel. The light source may have a configuration of first ultraviolet fluorescent lamps including a first fluorescent substance layers and second ultraviolet fluorescent lamps including a second fluorescent substance layer having a peak wavelength different from the peak wavelength of the first fluorescent substance layer. In the case, it is desired to dispose them alternately, so that the second fluorescent substance lamp is disposed next to the first fluorescent substance lamp. Furthermore, it is possible to control them so that the first fluorescent substance lamp and the second fluorescent substance lamp light up at different timings and outputs, thereby achieving a plurality of irradiation modes in which the wavelength and the intensity etc. of light differ.

Furthermore, the light source 31 may be an excimer lamp. The excimer lamp may have a cylindrical glass tube made from quartz glass etc., in which a gas and/or halogen are enclosed, at least one electrode is disposed outside the glass tube, and dielectric barrier electric discharge is generated. The glass tube may be a single pipe, or a double pipe including an inner pipe and an outer pipe disposed so as to cover the inner pipe, in which the inner pipe and the outer pipe are closed so as to form a discharge space enclosing a gas, between the pipes. The gas is selected so that 300 to 400 nm light is generated from the lamp. For example, if xenon and chlorine are enclosed in the glass tube, 308 nm light can be generated. If xenon is enclosed in the glass tube and a fluorescent substance layer converting 172 nm light generated by xenon into 300 to 400 nm light is formed on the inner wall of the glass tube, 300 to 400 nm light can be generated. As the fluorescent substance layer, a fluorescent substance layer containing a fluorescent substance, such as, LaPO4:Ce (trivalent cerium activated lanthanum phosphate), can be utilized. A pair of electrodes may be used, for example, and a configuration in which one of the electrodes is disposed inside the glass tube or on the inner wall of the glass wall and other is disposed outside the glass tube or on the outer wall of the glass tube, or a configuration in which both electrodes are disposed outside the glass tube or on the outer wall of the glass tube can be used. The electrode can have various shapes such as a rod-shape, a coil shape, a thin-film shape, and a plate shape.

Furthermore, the double-pipe liquid cooler 35, the long-wavelength-light cutting filter 33, and/or the short-wavelength-light cutting filter 34 are not necessarily required, and they can be omitted as appropriate.

FIG. 9 is a schematic view illustrating the configuration of another liquid crystal panel manufacturing apparatus according to the first embodiment.

As shown in FIG. 9, in the liquid crystal panel manufacturing apparatus 112 according to the embodiment, the treatment bath 10 includes a panel holder 15 for holding the panel 40. The panel holder 15 rotates the panel 40 about an axis in a direction perpendicular to a major surface (for example, the first major surface 40a) of the panel 40. For example, the arm 15c rotates about the axis 15b as an axis. Thereby, the panel 40 placed on the placement part 15d is rotated about the axis 15b as an axis.

That is, in the liquid crystal panel manufacturing apparatus 112, the panel 40 can be irradiated with light 30L, while being rotated.

Because of this, the temperature of the panel 40 is made uniform further in the face of the panel. In addition to this, the intensity of light 30L with which the panel 40 is irradiated, is made uniform further in the face of the panel.

### Second Embodiment

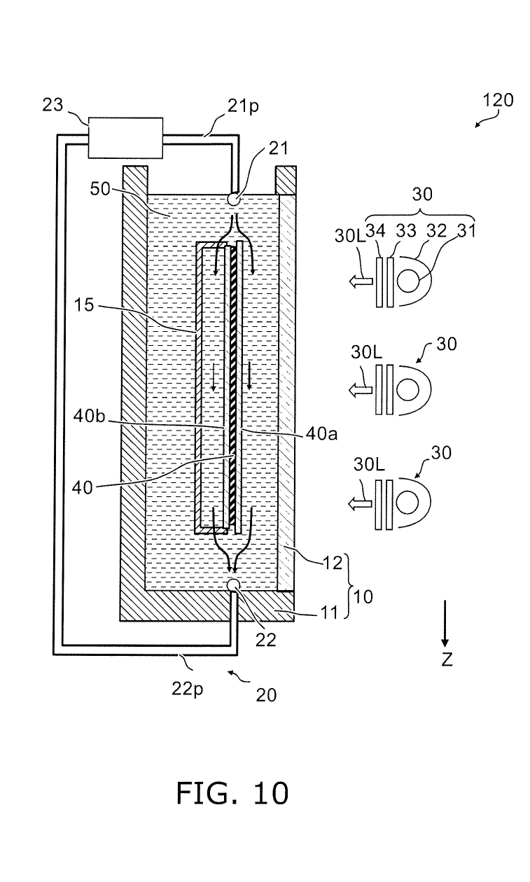

FIG. 10 is a schematic view illustrating the configuration of a liquid crystal panel manufacturing apparatus according to a second embodiment.

As shown in FIG. 10, the liquid crystal panel manufacturing apparatus 120 according to the embodiment includes a treatment bath 10, a window 12, a liquid flowing unit 20, and a light irradiation unit 30.

In the liquid crystal panel manufacturing apparatus 120, an axis directing from the light irradiation unit 30 toward the window 12 (an axis directing from the light irradiation unit 30 toward a portion of the window 12 nearest to the light irradiation unit 30) is substantially parallel to a direction of gravity (z-axis direction). For example, a major surface of the window 12 is substantially parallel to the z-axis direction. The major surface of the panel 40 is substantially perpendicular to the z-axis direction.

For example, a supplier 21 is formed at the upper portion of the treatment bath 10, and a drain 22 is formed at the lower portion. A liquid 50 is supplied from the supplier 21, and the liquid 50 flows downward and is discharged from the drain 22.

The liquid 50 between the panel 40 and the window 12 flows along a major surface (the first major surface 40a) of the panel 40. Furthermore, the liquid 50 being in contact with a plane (the second major surface 40b) on the side opposite to the window 12 of the panel 40 flows.

In the liquid crystal panel manufacturing apparatus 120, in-plane uniformity in the temperature of the panel 40 is also high. That is, the panel 40 can be irradiated with light 30L under a uniform condition. In the liquid crystal panel manufacturing apparatus 120, for example, installation area of the apparatus can be made small.

In addition, in the liquid crystal panel manufacturing apparatus 120, for example, the supplier 21 may be formed at the lower portion of the treatment bath 10, and the drain 22 may be formed at the upper portion.

In the first embodiment, the major surface of the panel 40 is substantially perpendicular to the z-axis direction, and in the second embodiment, the major surface of the panel 40 is substantially parallel to the z-axis direction, however, embodiments are not limited to this. In some embodiment, the major surface of the panel 40 may incline to the z-axis direction. By inclining the major surface of the panel 40 to the z-axis direction, for example, introducing the panel 40 into the liquid 50 and taking out the panel 40 from the liquid 50 become easy.

### Third Embodiment

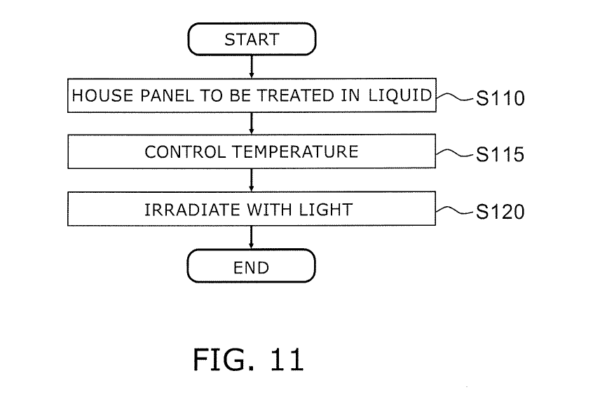

FIG. 11 is a flow chart view illustrating a method for manufacturing a liquid crystal panel according to a third embodiment.

As shown in FIG. 11, in the method for manufacturing the liquid crystal panel according to the embodiment, a panel 40 is housed in the liquid 50 introduced inside the treatment bath 10 provided with the light transmissive window 12 (step S110).

While causing the liquid 50 in contact with the panel 40 and the window 12 to flow along a major surface (for example, the first major surface 40a) of the panel 40, the panel 40 is irradiated with light 30L for polymerizing a photo-polymerizable material (step S120).

Thus, in-plane uniformity in the temperature of the panel 40 becomes high. According to the manufacturing method, the panel 40 can be irradiated with light under a uniform condition.

As shown in FIG. 11, the temperature of the liquid crystal layer 43 is controlled, for example, between step S110 and step S120. For example, by making the temperature of the panel 40 to be uniform, a blue phase is caused to appear throughout the whole of the panel 40. Therefore, in step S120, for example, the panel 40 is irradiated with light 30L after the temperature of the liquid crystal layer 43 is controlled so that a blue phase appears throughout the whole of the liquid crystal layer 43. Thus, a uniform characteristics liquid crystal panel with a polymer-stabilized blue phase is achieved.

In the manufacturing method, the temperature of the liquid 50 is controlled (step S115). Furthermore, the panel 40 can be irradiated with light 30L, rotating the above-mentioned panel to be treated centering around a perpendicular direction to the major surface of the panel 40.

The panel 40 can be irradiated with light 30L, while further causing the liquid 50 in contact with a plane (the second major surface 40b) on the side opposite to the window 12 of the panel 40, to flow.

The major surface of the panel 40 is substantially perpendicular to the direction of gravity. Alternatively, the major surface of the panel 40 is substantially parallel to the direction of gravity. Alternatively, the major surface of the panel 40 inclines toward the direction of gravity.

The temperature of the panel 40 at the time of being irradiated with light 30L is not less than 40° C. The effect for suppressing generation of haze is especially exerted.

Irradiation of the panel 40 with light 30L includes irradiation via at least one of the short-wavelength-light cutting filter 34 for attenuating light having a wavelength of not more than 340 nm, and the long-wavelength-light cutting filter 33 for attenuating light having a wavelength longer than the wavelength of light polymerizing a photo-polmerizable material.

The liquid crystal layer 43 can have a blue phase. In a polymer-stabilized blue phase, especially it is required that temperature of the panel 40 when the panel 40 is irradiated with light 30L is controlled with a high degree of accuracy. By applying the manufacturing method to the polymer-stabilized blue phase, light irradiation can be performed under a uniform condition, thereby being able to manufacture a liquid crystal having desired characteristics.

A blue phase has, for example, a frustration-based configuration having a double twist structure. The liquid crystal layer 43 made of the blue phase has, for example, a three-dimensional periodic structure having a length corresponding to the wavelength of visible light. In the blue phase, for example, characteristics of photonics can be achieved. Furthermore, in the blue phase, a high speed electro-optics response can be achieved.

However, in the embodiment, the configuration of the panel 40 is arbitrary.

In the panel 40, for example, the first substrate 41 includes a plurality of thin film transistors (TFT). A pixel electrode is connected to each of the plurality of thin film transistors. A color filter is provided on one of the first substrate 41 and the second substrate 42. It is desirable that the liquid crystal layer 43 is irradiated with light 30L via a substrate not provided with the color filter. Because of this, for example, absorption of light 30L by the color filter can be suppressed. Thereby, temperature rise can be suppressed. Furthermore, degradation of the characteristics of the color filter can also be suppressed.

In this way, the panel 40 can include a color filter substrate having a color filter, a counter substrate (for example, a TFT substrate) facing the color filter substrate, and a liquid crystal layer provided between the color filter substrate and the counter substrate. The counter substrate can be provided with, for example, a plurality of thin film transistors. Furthermore, a color filter may also be provided on a substrate provided with a plurality of thin film transistors.

The light irradiation unit 30 irradiates the panel 40 with light from the side of the counter substrate. In addition to this, the liquid flowing unit 20 can cause the liquid 50 in contact with a face on the side of the panel 40, to flow and can further cause the liquid 50 in contact with a plane on the side opposite to the window 12 of the panel 40, to flow. Temperature rise can be suppressed by irradiating the panel 40 with light from the side of the counter substrate. Since temperature rises, even when the panel 40 is irradiated with light from the side of the counter substrate, the liquid body 50 on the side of the color substrate is caused to flow, and thus temperature rise can be suppressed.

In the panel 40, a counter electrode facing the picture electrode is provided on the second substrate 42. An electric field located along an axis directing from the first substrate 41 to the second substrate 42 is applied to the liquid crystal layer 43.

Alternatively, for example, the first substrate is provided with a counter electrode facing the pixel electrode. An electric field having a component located perpendicular to an axis directing from the first substrate 41 to the second substrate 42 is applied to the liquid crystal layer 43.

According to the first to third embodiments, liquid crystal panel manufacturing apparatuses and a method for manufacturing a liquid crystal panel, capable of irradiating a panel with light under a uniform condition, are provided.

### Fourth Embodiment

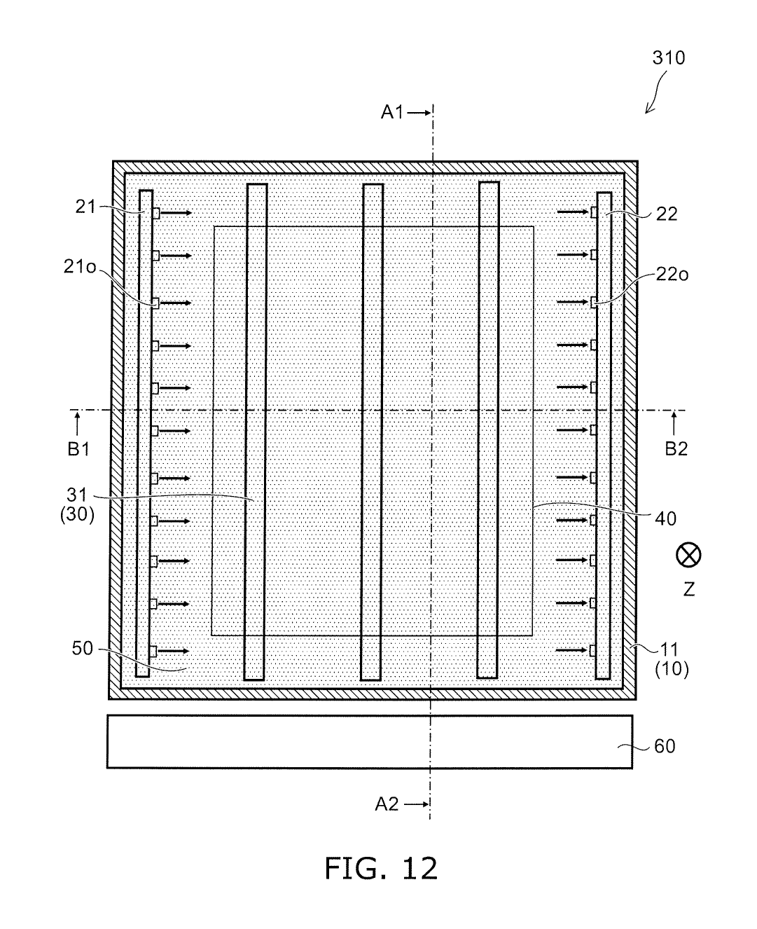

FIG. 12 is a schematic plan view illustrating the configuration of a liquid crystal manufacturing apparatus according to a fourth embodiment.

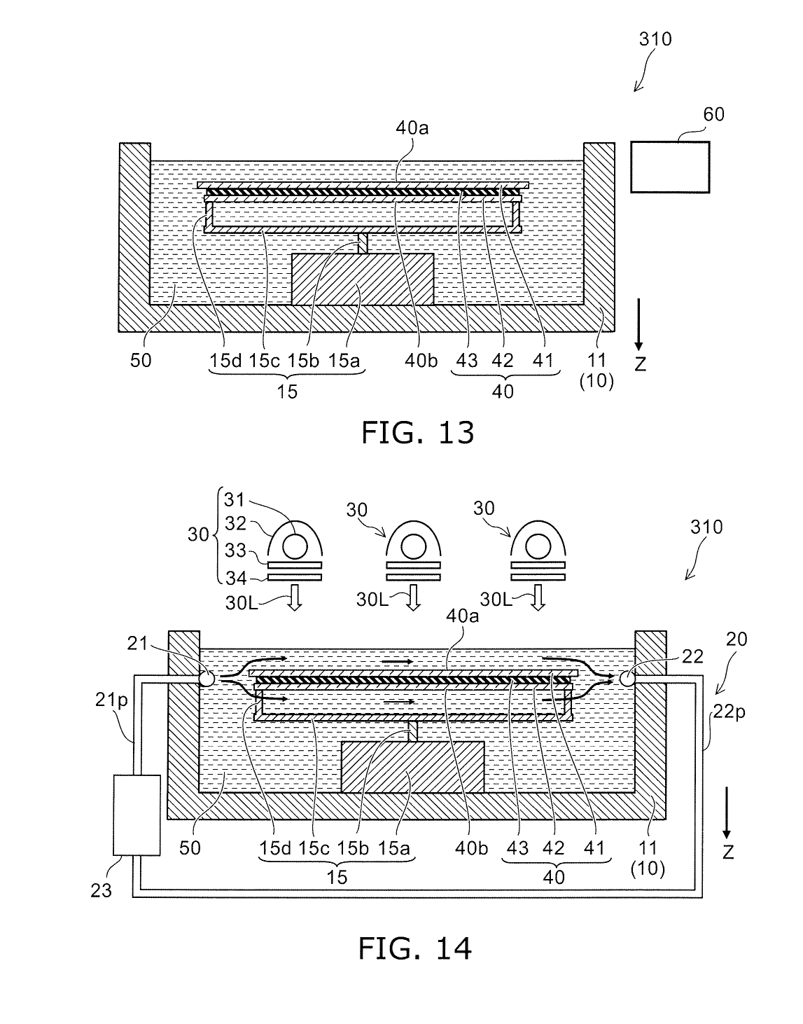

FIG. 13 is a schematic cross-sectional view illustrating the configuration of the liquid crystal manufacturing apparatus according to the fourth embodiment.

That is, FIG. 13 illustrates the cross-section along line A1-A2 in FIG. 12.

FIG. 14 is a schematic view illustrating the configuration of the liquid crystal panel manufacturing apparatus according to the fourth embodiment.

That is, in FIG. 14, cross-sections of some constituent elements (cross-sections along line B1-B2 in FIG. 12) are shown, and some of others are shown schematically.

In FIG. 12, some of the elements illustrated in FIGS. 13 and 14 are omitted.

As shown in FIGS. 12 to 14, the liquid crystal panel manufacturing apparatus 310 according to the embodiment includes a treatment bath 10, a light irradiation unit 30, and a liquid remover 60.

The treatment bath 10 retains a liquid 50 therein. The treatment bath houses a panel 40 in the liquid 50.

The light irradiation unit 30 irradiates the panel 40 housed inside the treatment bath 10 with light 30L for polymerizing a photo-polymerizable material.

The configuration described with regard to the first embodiment can be applied to the treatment bath 10 and the light irradiation unit 30, and thus the description is omitted. The configuration described with regard to the first embodiment can be applied to the panel 40, and thus the description is omitted.

The liquid crystal panel manufacturing apparatus 310 can further include the liquid flowing unit 20. The configuration described with regard to the first embodiment can be applied to the liquid flowing unit 20, and thus the description is omitted.

The liquid remover 60 removes the liquid 50 adhered to at least a portion of the panel 40, the portion being taken out from the liquid 50. The liquid remover 60 removes the liquid 50 adhered to the panel 40 after being taken out from the liquid 50. Alternatively, the liquid remover 60 removes the liquid 50 adhered to the portion of the panel 40 taken out from the liquid 50, for the panel 40 which is going to be taken out from the liquid 50. For example, in a case where a portion of the panel 40 is housed in the liquid 50 and the remaining portion is taken out from the liquid 50, the liquid remover 60 removes the liquid 50 adhered to the remaining portion.

The liquid crystal manufacturing apparatus 310 according to the embodiment, can remove the liquid 50 adhered to the panel 40 using the liquid remover 60. Thereby, adverse effects on processes after the light 30L irradiation process can be suppressed. According to the embodiment, a practical liquid crystal manufacturing apparatus for irradiating the panel 40 with light 30L can be provided.

In the embodiment, it is desirable to remove the liquid 50 adhered to the panel 40 as soon as possible. Thus, traces of the liquid drops of the liquid 50 hardly remain. For example, the liquid 50 is removed by bombarding air jet to the panel 40 while taking-out the panel 40 from the liquid 50. For example, in an operation of taking-out the panel 40, the liquid 50 can be blown out. It is desirable to return the removed liquid 50 into the treatment bath 10.

Hereinafter, an example of the liquid remover 60 will be described.

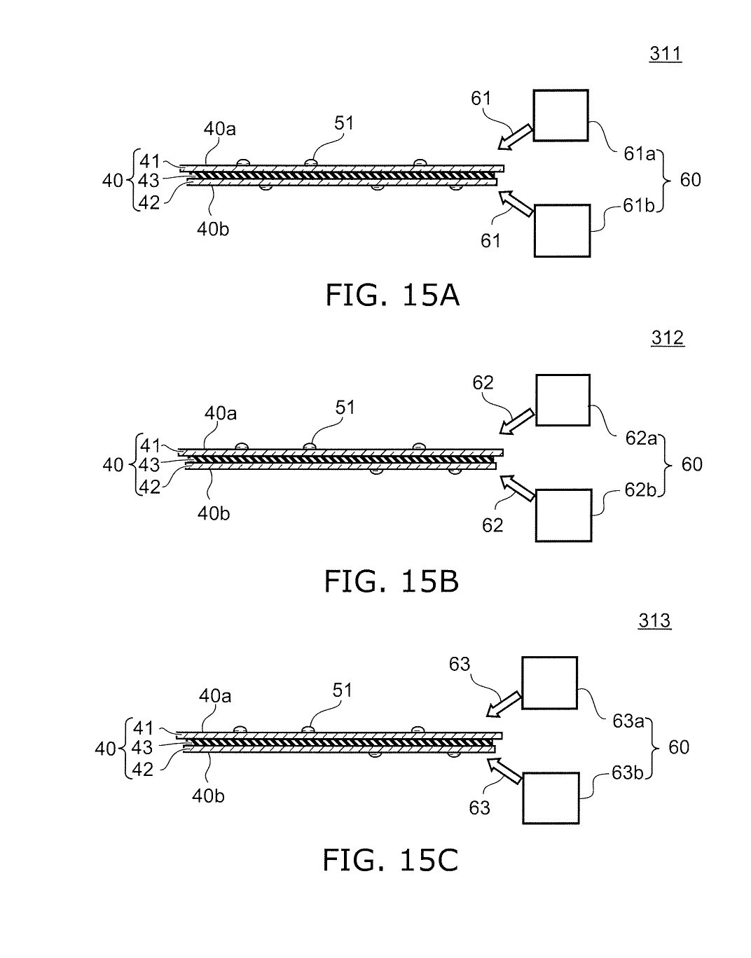

FIGS. 15A to 15C are schematic views illustrating some configurations of liquid crystal panel manufacturing apparatuses according to the fourth embodiment.

As shown in FIG. 15A, in the liquid crystal panel manufacturing apparatus 311 according to the embodiment, the liquid remover 60 blows gas stream 61 onto the panel 40. Specifically, the liquid remover 60 includes a first gas blowing part 61a and a second gas blowing part 61b. The first gas blowing part 61a blows the gas stream 61 onto the first major surface 40a of the panel 40. The second gas blowing part 61b blows the gas stream 61 onto the second major surface 40b of the panel 40. The gas stream 61 is, for example, air. The first gas blowing part 61a and the second gas blowing part 61b are, for example, air blowers. Liquid drops 51 of the liquid 50 adhered to the panel 40 can be removed by the gas stream 61.

As shown in FIG. 15B, in the liquid crystal panel manufacturing apparatus 312 according to the embodiment, the liquid remover 60 heats the panel 40. Specifically, the liquid remover 60 includes a first heating part 62a and a second heating part 62b. The first heating part 62a irradiates the first major surface 40a of the panel 40 with infrared light 62. The second heating part 62b irradiates the second major surface 40b of the panel 40 with infrared light 62. Liquid drops 51 of the liquid 50 adhered to the panel 40 can be removed by infrared light 62.

As shown in FIG. 15C, in the liquid crystal panel manufacturing apparatus 313 according to the embodiment, the liquid remover 60 blows the hot and high-pressure gas steam 63 onto the panel 40. Specifically, the liquid remover 60 includes a first hot-gas blowing part 63a and a second hot-gas blowing part 63b. The first hot-gas blowing part 63a blows the hot-gas stream 63 onto the first major surface 40a of the panel 40. The second hot-gas blowing part 63b blows the hot-gas stream 63 onto the second major surface 40b of the panel 40. The hot-gas stream 63 is, for example, hot air. Liquid drops 51 of the liquid 50 adhered to the panel 40 can be removed by the hot-gas stream 63. In the liquid crystal panel manufacturing apparatus 313, the liquid remover 60 blows gas stream (hot-gas stream 63) onto the panel 40, while heating the panel 40.

Furthermore, as the liquid remover 60, for example, a configuration in which the liquid 50 is removed in a mechanical manner, can be used. For example, as the liquid remover 60, a flexible structure in contact with the panel 40 can be used. Specifically, a spatula (such as, a squeegee, a wiper blade) made of, for example, a rubber-like material can be used as the liquid remover 60.

Various kinds of configurations for the liquid remover 60 can be used in combination thereof. For example, the liquid remover 60 can include a gas blowing part and a heating part. For example, a large portion of the liquid 50 adhered to the panel 40 is removed by air jet, and remaining few liquid 50 can be surely removed by a heater. As the liquid remover 60, an arbitrary plurality of configurations may be included.

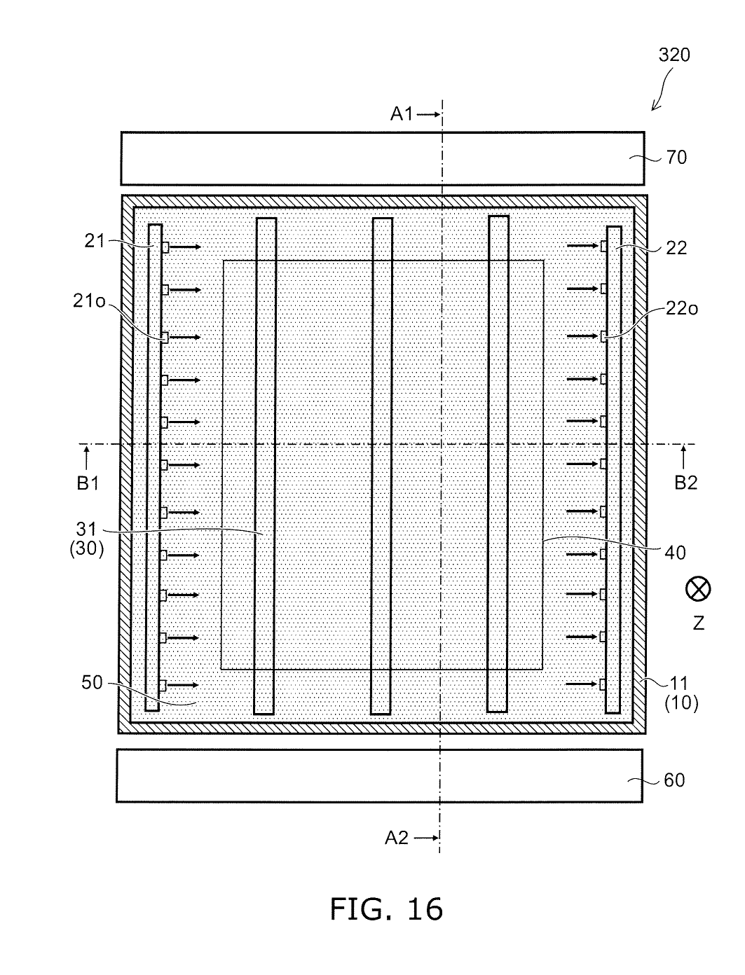

FIG. 16 is a schematic plan view illustrating the configuration of another liquid crystal panel manufacturing apparatus according to the fourth embodiment.

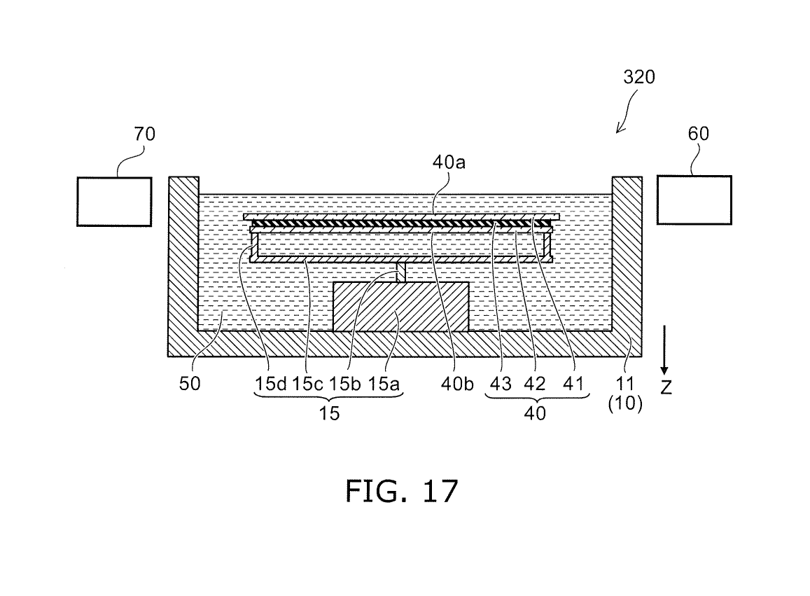

FIG. 17 is a schematic cross-sectional view illustrating the configuration of the another liquid crystal panel manufacturing apparatus according to the fourth embodiment.

That is, FIG. 17 illustrates the cross-section along line A1-A2 in FIG. 16.

Since the cross-section along line B1-B2 in FIG. 16 is the same as the cross-section in FIG. 14, it is not shown.

As shown in FIGS. 16 and 17, the liquid crystal panel manufacturing apparatus 320 according to the embodiment, further includes a wettability improver 70. The wettability improver 70 improves wettability of the surface of the panel 40, before housing the panel 40 in the liquid 50.

Thereby, when the panel 40 is housed in the liquid 50, adhesion of air bubbles etc. to the surface of the panel 40 can be suppressed. If the panel 40 is irradiated with light 30L in a state where the air bubbles etc. are adhered to the surface of the panel 40, irradiance distribution may be non-uniform, and temperature distribution may be non-uniform.

In contrast to this, since the wettability improver 70 can suppress adhesion of air bubbles etc. to the surface of the panel 40, uniformity in irradiance and uniformity in temperature can be improved.

For example, the wettability improver 70 treats the surface of the panel 40 with plasma. For example, the wettability improver 70 subjects the panel 40 to atmospheric pressure plasma treatment. For example, the wettability improver 70 irradiates the surface of the panel 40 with UV light. For example, the wettability improver 70 treats the surface of the panel 40 with a cleaning liquid. By these treatments, wettability of the surface of the panel 40 can be improved.

In a case where the wettability improver 70 irradiates the panel 40 with UV light, it is desirable for the wavelength of UV light to be shorter than the wavelength of UV light with which the panel 40 is irradiated in the liquid 50. That is, it is desirable for the wavelength of UV light with which the wettability improver irradiates the panel 40 to be shorter than the wavelength of light 30L (UV light) with which the light irradiation unit 30 irradiates the panel 40. The wavelength (major wavelength) of UV light irradiated by the wettability improver 70 is, for example, 185 nm or 254 nm. The wavelength (major wavelength) of UV light irradiated by the light irradiation unit 30 is, for example, 340 nm. Thereby, advance of polymerizing of a photo-polymerizable material can be suppressed by UV light irradiated by the wettability improver 70. For example, it is desirable for the energy of UV light irradiated by the wettability improver 70 to be lower than the energy of light 30L irradiated by the light irradiation unit 30.

In the liquid crystal panel manufacturing apparatus according to the embodiment, a treatment bath 10 may be provided with a window 12. A light source 31 (light irradiation unit 30) is provided outside the window 12.

Also in the liquid crystal panel manufacturing apparatuses according to the embodiment, the light irradiation unit 30 can include a light source 31 and a double-pipe liquid cooler 35.

In the liquid crystal panel manufacturing apparatus according to the embodiment, the panel holder 15 may rotate the panel 40 about an axis in a direction perpendicular to a major surface (for example, the first major surface 40a) of the panel 40.

Also in the liquid crystal panel manufacturing apparatus according to the embodiment, an axis directing from the light irradiation unit 30 toward a position of the treatment bath 10 for housing the panel 40 (an axis directing from the light irradiation unit 30 toward the portion of the position of the treatment bath 10 for housing the panel 40 nearest to the light irradiation unit 30) may be substantially perpendicular to a direction of gravity (z-axis direction). For example, the major surface of the panel 40 is substantially parallel to the z-axis direction.

Also in the embodiment, the liquid crystal layer 43 can have, for example, a blue phase. However, in the embodiment, the configuration of the panel 40 is arbitrary.

### Fifth Embodiment

A fifth embodiment relates to a method for manufacturing a liquid crystal panel.

The manufacturing method includes housing the panel 40 including a liquid crystal layer 43 containing a photo-polymerizable material and a liquid crystal composition, in the liquid 50 introduced inside the treatment bath 10 (step S310).

The manufacturing method further includes irradiating the panel 40 with light 30L for polymerizing a photo-polymerizable material (step S320).

The manufacturing method further includes removing the liquid 50 adhered to at least a portion of the panel 40, the portion being taken out from the liquid 50 (step S330).

In the removing process, for example, at least one of various kinds of methods described with regard to FIGS. 15A to 15C and mechanical methods, can be used. A combination of a plurality of approaches can be used.

According to the fourth and fifth embodiments, practical liquid crystal manufacturing apparatuses and methods for manufacturing liquid crystal for irradiating a panel to be treated with light are provided.

In the specification of the application, “perpendicular” and “parallel” refer to not only strictly perpendicular and strictly parallel but also include, for example, the fluctuation due to manufacturing processes, etc. It is sufficient to be substantially perpendicular and substantially parallel.

Hereinabove, exemplary embodiments of the invention are described with reference to specific examples. However, the invention is not limited to these specific examples. For example, one skilled in the art may similarly practice the invention by appropriately selecting specific configurations of components included in liquid crystal panel manufacturing apparatuses such as treatment baths, windows, liquid flowing units, light irradiation units, light sources, etc., from known art. Such practice is included in the scope of the invention to the extent that similar effects thereto are obtained.

Further, any two or more components of the specific examples may be combined within the extent of technical feasibility and are included in the scope of the invention to the extent that the purport of the invention is included.

Moreover, all liquid crystal panel manufacturing apparatuses and manufacturing methods of a liquid crystal panel practicable by an appropriate design modification by one skilled in the art based on the liquid crystal panel manufacturing apparatuses and manufacturing methods of a liquid crystal panel described above as embodiments of the invention also are within the scope of the invention to the extent that the purport of the embodiments of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A liquid crystal panel manufacturing apparatus comprising:
a treatment bath configured to contain a liquid and to treat a panel in the liquid, wherein the panel includes a liquid crystal layer having a photo-polymerizable material and a liquid crystal composition;
a light transmissive window provided in the treatment bath;
a liquid flowing unit configured to cause the liquid to flow along a major surface of the panel; and
a light irradiation unit configured to irradiate the panel with a light to polymerize the photo-polymerizable material via the light transmissive window.

2. The apparatus according to claim 1, wherein
the panel to be treated further includes:
a color filter substrate having a color filter; and
a counter substrate facing the color filter substrate; wherein
the liquid crystal layer is located between the color filter substrate and the counter substrate,
the light irradiation unit irradiates the panel to be treated with the light from a side of the counter substrate, and
the liquid is in contact with a plane of the panel on a side opposite to the window.

3. The apparatus according to claim 1, wherein the light irradiation unit includes:
a light source configured to emit the light to polymerize the photo-polymerizable material; and
a double-pipe liquid cooler including an inner pipe separated from the light source, an outer pipe provided outside the inner pipe, and a middle wall provided between the inner pipe and the outer pipe, wherein the light source is in the inner pipe.

4. The apparatus according to claim 1, wherein a difference between maximum temperature and minimum temperature in the panel to be treated when the panel to be treated is irradiated with the light is not more than 5° C.

5. The apparatus according to claim 1, wherein the liquid flowing unit includes a temperature controller configured to control a temperature of the liquid.

6. The apparatus according to claim 5, wherein the liquid flowing unit circulates the liquid along a path between the treatment bath and the temperature controller.

7. The apparatus according to claim 1, wherein the temperature controller controls a temperature of the liquid to a temperature within a range of not less than 25° C. and not more than 90° C.

8. The apparatus according to claim 1, wherein a flow rate of the liquid between the panel to be treated and the window is not less than 1 meter/second and not more than 10 meter/second.

9. The apparatus according to claim 1, wherein
the light irradiation unit includes:
a light source configured to generate the light; and
a filter configured to filter the light to obtain an output light having a wavelength of not less than 400 nanometers.

10. The apparatus according to claim 1, wherein the light irradiation unit includes a filter configured to filter a light to obtain an output light having a wavelength of not more than 340 nanometers.

11. The apparatus according to claim 1, wherein
the light transmissive window includes a frame and an inside part inside the frame, the frame having a first face in contact with the liquid, the inside part having a second face in contact with the liquid,
a thickness of the frame is thicker than a thickness of the inside part, and
the first face is located in a plane including the second face.

12. The apparatus according to claim 1, wherein an axis directing from the light irradiation unit to the window is perpendicular to a direction of gravity.

13. The apparatus according to claim 1, wherein an axis directing from the light irradiation unit to the window is parallel to a direction of gravity.

14. The apparatus according to claim 1, wherein the liquid crystal layer is a blue phase liquid crystal layer.

15. The apparatus according to claim 1, wherein the light transmissive window contacts the liquid.

16. A method for manufacturing a liquid crystal panel comprising:
housing a panel to be treated in a liquid inside a treatment bath provided with a light transmissive window, the panel to be treated including a liquid crystal layer having a photo-polymerizable material and a liquid crystal composition; and
irradiating the panel with a light to polymerize the photo-polymerizable material via the light transmissive window while causing the liquid in contact with the panel and the window to flow along a major surface of the panel.

17. A liquid crystal panel manufacturing apparatus comprising:
a treatment bath configured to contain a liquid and to treat a panel in the liquid, wherein the panel includes a liquid crystal layer having a photo-polymerizable material and a liquid crystal composition;
a light irradiation unit irradiating the panel to be treated housed in the inside of the treatment bath with a light to polymerize the photo-polymerizable material; and
a liquid remover configured to remove the liquid on at least a portion of the pane.

18. The apparatus according to claim 17, wherein the liquid remover configured to provide a gas stream onto the panel.

19. The apparatus according to claim 17, further including a wettability improver configured to control surface wettability of the panel.

20. A method for manufacturing a liquid crystal panel comprising:
housing a panel to be treated in a liquid introduced inside a treatment bath, the panel to be treated including a liquid crystal layer having a photo-polymerizable material and a liquid crystal composition;
irradiating the panel to be treated with a light to polymerize the photo-polymerizable material; and
removing the liquid on at least a portion of the panel to be treated.
